(19) United States
(12) Patent Application Publication
(10) Pub. No.: US 2016/0376986 A1
(43) Pub. Date: Dec. 29, 2016

(54) Dual Purpose Heat Transfer Surface Device

(71) Applicant: HRST, Inc., Eden Prairie, MN (US)

(72) Inventors: Victor Ferris, Minneapolis, MN (US); Samuel Shaw, Milfor, ME (US); Robert James Krowech, Eden Prairie, MN (US)

(73) Assignee: HRST, Inc., Eden Prairie, MN (US)

(21) Appl. No.: 15/189,193

(22) Filed: Jun. 22, 2016

Related U.S. Application Data
(60) Provisional application No. 62/184,364, filed on Jun. 25, 2015.

(51) Int. Cl. F02C 6/18; F02G 5/02

(52) U.S. Cl. CPC F02C 6/18; F02G 5/02

(57) ABSTRACT

A heat transfer panel, or multiple panels, utilized to absorbed heat from the turbine exhaust gas as part of the Rankin cycle which simultaneously distributes the exhaust gas through the waste heat boiler. The panel varies the gas flow characteristics across a transverse and longitudinal plane, thereby eliminating the need for a separate flow distribution device.

### CROSS-REFERENCE TO RELATED APPLICATIONS

This application claims the benefit of U.S. Provisional Patent Application Ser. No. 62/184,364 filed Jun. 25, 2015, which is incorporated by reference herein in its entirety.

### FIELD OF THE INVENTION

The present invention in general relates to flow distribution devices within waste heat boilers.

### BACKGROUND OF THE INVENTION

A duct burner or SCR (Selective Catalytic Reduction Reactor) of a waste heat boiler will receive heated exhaust from a combustion turbine, or other source, and use the heat from that exhaust to generate steam. Heat transfer tubes are located downstream from the exhaust from a combustion turbine. The heat transfer tubes employ extended surfaces to facilitate heat transfer from the gas turbine exhaust to the boiler working fluid. FIGS. 1, 2, and 3 represent typical tube surfaces. FIG. 1 depicts a typical tube panel. FIG. 1 is vertical view of a typical tube panel which is disposed adjacent to the exhaust port for a combustion turbine. One of the functions of the typical tube panel is to adjust the velocity profile of the exhaust gas exiting the exhaust port of the combustion turbine. FIG. 2 depicts a typical tube surface. FIG. 3 depicts a close-up of a typical tube surface. In some embodiments, as depicted in FIG. 2 and FIG. 3, the extended surface or fins may be secured about or be integral to the perimeter of a heat transfer tube. In some embodiments, heat transfer tubes located proximate to a duct burner or SCR for a waste heat boiler as shown in FIGS. 2 and 3 are exposed to the heated exhaust from the combustion turbine and use the heat from that exhaust to generate steam. The heat transfer tubes located downstream from the exhaust for a combustion turbine employ extended surfaces to facilitate heat transfer from the gas turbine exhaust to the boiler working fluid. Generally, the heat transfer tubes located proximate to a duct burner or SCR for a waste heat boiler will have an outside diameter between 1.25 and 2.25 inches.

FIG. 4 is a horizontal view directed at the exhaust port for a combustion turbine. Exterior and proximate to the exhaust port for the combustion turbine is located a turning vane. The elevation, angled orientation, or rotational orientation/position of the turning vane, or sections or portions of the turning vane, relative to the exhaust port for the combustion turbine, will affect the direction and/or velocity profile of the exhaust gas, which will pass through the chamber and which may ultimately enter into a critical component within a Heat Recovery Steam Generator.

FIG. 5 shows a horizontal view directed at the exhaust port for the combustion turbine where a perforated plate is disposed over the exhaust port. The perforated plate has numerous sections having the same or different configurations. Different configurations of plates may be used to adjust the velocity profile of the exhaust gas exiting the exhaust port of the combustion turbine. The configuration of the perforated plates will affect the direction and/or velocity profile of the exhaust gas, which will pass through the chamber and which may ultimately enter into a critical component within a Heat Recovery Steam Generator.

In some configurations, the turbine exhaust gas entering the waste heat boiler enters the boiler non-uniformly across the transverse internal area of the waste heat boiler. Exhaust gas velocity exiting the combustion or gas turbine may pass at a velocity of typically 80-100 ft/sec and the localized velocity may sometimes be as high as 250 ft/sec depending on the make and model of the gas or combustion turbine. Also, the exhaust gas exiting the combustion turbine may exit the combustion turbine at a gas swirl angle which may vary depending on make and model of the turbine. The exhaust gas swirl angle may occur at an angle of approximately 20 degrees clockwise and/or 20 degrees counterclockwise. In some embodiments, various components such as a duct burner will require an even flow distribution of heated exhaust gas to function or operate within normal parameters.

At the present there are two general methods for attempting to achieve a satisfactory flow distribution for exhaust gas exiting the exhaust port of the combustion turbine prior to entry into a waste heat boiler or other critical component. As seen in FIG. 1, flow directing vanes can be installed in an upstream location. The vanes redistribute the exhaust gas flow. The use of vanes to redistribute the exhaust gas flow have fallen out of favor in recent years because the velocity profile entering the vanes is only approximately known at best; and the velocity profile downstream may not be sufficiently uniform. Additionally, or in an alternative, during use, the vanes are uncooled and are subject to high temperatures and high levels of turbulence. In the past the reliability and/or durability of the vanes has been an issue.

As seen in FIG. 5, perforated plates are the most common way of smoothing the velocity profile for exhaust gas exiting the exhaust port of the combustion turbine. The perforated plate consists of a flat plate with zones of open area creating a variable pressure drop which redistributes the exhaust flow. Perforated plates are a less than optimum method of distributing flow because the perforated plates are subject to high temperatures, and the pressure drop across the plate reduces efficiency, is difficult to regulate, and is inconsistent. If a perforated plate is located upstream, then the perforated plate is subject to high turbulence which may cause the perforated plate to become a high maintenance item or component. Further, perforated plates add pressure drop to the system, thereby reducing the system efficiency.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All U.S. patents and applications and all other published documents mentioned anywhere in this application are incorporated herein by reference in their entirety.

Without limiting the scope of the invention, a brief description of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided for the purposes of complying with 37 C.F.R. §1.72.

### GENERAL DESCRIPTION OF THE INVENTION

As an alternative to specific flow distribution devices, the design and installation of a heating surface having a sufficient number of rows and/or configuration of heat transfer tubes adequately regulates the resulting pressure drop and provides an acceptable distribution/redistribution of the exhaust gas exiting the exhaust port of the combustion turbine.

In some embodiments, a heat transfer panel, comprised of a plurality of vertically or horizontally orientated heat transfer tubes, or multiple panels of heat transfer tubes, are utilized to absorb heat from the turbine exhaust gas as part of the Rankin cycle, which simultaneously distributes the exhaust gas through the duct burner and/or waste heat boiler.

In some embodiments, a heat transfer panel, or multiple panels vary the exhaust gas flow characteristics from a gas or combustion turbine across a transverse and longitudinal plane, thereby eliminating the need for a separate flow distribution device. The heat transfer panel, or multiple panels may have varied extended surface characteristics disposed along the length of the heat transfer tubes. Alternatively, the heat transfer tube to heat transfer tube separation or relative spacing distance in either the transverse or longitudinal direction may be modified to achieve the differential flow characteristics required to redistribute the exhaust gas flow across a transverse plane. One alternative in addition to heat transfer of this panel, may be to create uniform gas flow and a desired velocity profile for the exhaust gas.

In some embodiments there may be a small number of rows of heat absorbing heat transfer tubes upstream of the duct burner or other critical component. The pressure drop across the rows of heat absorbing tubes improves the velocity profile of the exhaust gas flow, but the velocity profile is usually not sufficient to satisfy the desired velocity profile at the duct burner or other critical component. Note that a large tube bank upstream of the duct burner or other critical component would sufficiently improve the velocity profile, but thermal design constraints typically dictate the use of a small tube bank upstream of the duct burner or other critical component.

In some embodiments a panel or multiple panels of heat transfer tubes may be utilized in either original design or retrofit applications between a gas or combustion turbine and a duct burner or other critical component.

In some of the embodiments, each of the panels or multiple panels of heat transfer tubes will include fins. In some embodiments, the varying of the fin density and/or heat transfer tube spacing (as another pressure drop influencing parameter) where the heat transfer tubes are located upstream from the duct burner or other critical component, will function in a manner similar to a perforated plate of varying porosity. The use of panels or multiple panels of heat transfer tubes having fins, and the spacing of the heat transfer tubes relative to each other, may provide a tremendous performance advantage over a perforated plate. The use of panels or multiple panels of heat transfer tubes having fins and the spacing of the heat transfer tubes relative to each other may eliminate additional pressure drop through the system. The heat transfer tube bank pressure drop is normal and expected in the system. In addition, the expense of a perforated plate or vane assembly is avoided. Further the tube banks are cooled and robust and no additional maintenance cost is required.

In a first alternative embodiment, a heat transfer device is disclosed comprising: a plurality of tubes, the plurality of tubes being disposed in rows of tubes, the rows of tubes forming a tube panel; and a plurality of fins engaged to each of the plurality of tubes; wherein the plurality of rows of tubes are vertically organized into a least a first pressure drop zone and a second pressure drop zone.

In a second alternative embodiment according to the first alternative embodiment, the plurality of tubes within at least one of the rows of tubes are uniformly spaced relative to another of the tubes within the at least one row of tube.

In a third alternative embodiment according to the first alternative embodiment, the plurality of tubes within at least one of the rows of tubes are irregularly spaced relative to another of the tubes within the at least one row of tubes.

In a fourth alternative embodiment according to the first alternative embodiment, the plurality of tubes within the first pressure drop zone are separated from each other a first distance, and the plurality of tubes within the second pressure drop zone are separated from each other a second distance, the first distance having a different dimension as compared to the second distance.

In a fifth alternative embodiment according to the first alternative embodiment, a first number of fins are engaged to each of the plurality of tubes in the first pressure drop zone and a second number of fins are engaged to each of the plurality of tubes in the second pressure drop zone, the first number of fins being different from the second number of fins.

In a sixth alternative embodiment according to the second alternative embodiment, the spacing between adjacent tubes in a row of tubes is identified as a transverse tube spacing having a dimension, the spacing being constructed and arranged to be variable and to modify a gas flow characteristic of the heat transfer device to achieve a desired flow distribution.

In a seventh alternative embodiment according to the first alternative embodiment, the tube panel is constructed and arranged to act as a heat transfer surface and is constructed and arranged to distribute turbulent combustion turbine exhaust flow.

In an eighth alternative embodiment according to the fifth alternative embodiment, the first number of fins and the second number of fins are constructed and arranged to establish a desired exhaust gas flow distribution downstream from the tube panel.

In a ninth alternative embodiment according to the first alternative embodiment, the tube panel comprises a panel upper header and a panel lower header, each of the panel upper header and the panel lower header having a header nozzle.

In a tenth alternative embodiment according to the first alternative embodiment, the heat transfer device further comprises tube ties, wherein the tube ties secure the plurality of tubes into the first pressure drop zone and the second pressure drop zone.

In an eleventh alternative embodiment according to the first alternative embodiment, at least one of the plurality of rows of tubes are vertically organized into an intermediate pressure drop zone.

In a twelfth alternative embodiment according to the eleventh alternative embodiment, the plurality of tubes within the intermediate pressure drop zone are separated from each other a third distance, the third distance being smaller than the second distance and the third distance being larger than the first distance.

In a thirteenth alternative embodiment according to the twelfth alternative embodiment, a third number of fins is engaged to each of the plurality of tubes in the intermediate pressure drop zone, the third number of fins being larger than the second number of fins, and the third number of fins being smaller than the first number of fins.

In a fourteenth alternative embodiment according to the thirteenth alternative embodiment, the first number of fins, the third number of fins, and the second number of fins are constructed and arranged to establish a desired exhaust gas flow distribution downstream from the tube panel.

In another alternative embodiment, a tube panel, or multiple panels will act as both a heat transfer surface utilized in a waste heat boiler as part of the Rankin cycle, as well as a device to distribute turbulent combustion turbine exhaust flow for downstream components which require uniform gas flow.

In another alternative embodiment, a tube panel, or multiple panels have extended surfaces, where the extended surfaces along the length of the tubes is varied in order to achieve a desired exhaust gas flow distribution.

In another alternative embodiment, a tube panel, or multiple panels include a longitudinal tube spacing between the tubes which is varied to modify the gas flow characteristics to achieve desired flow distribution.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE DRAWINGS

FIG. 1 depicts a typical tube panel of the prior art;

FIG. 2 depicts a typical tube surface of the prior art;

FIG. 3 depicts a close-up of a typical tube surface of FIG. 2 of the prior art;

FIG. 4 shows a turning vane proximate to an exhaust port of a combustion turbine of the prior art;

FIG. 5 shows a horizontal view of a exhaust port of a combustion turbine having a perforated plate disposed over the exhaust port of the prior art;

FIG. 6 depicts a system schematic of one alternative embodiment of a heating system including a perforated plate of the prior art;

FIG. 7 depicts a system schematic of one alternative embodiment of a heating system including a turning vane of the prior art;

FIG. 8 depicts a system schematic of one alternative embodiment of the invention having a dual function heat transfer surface;

FIG. 9 depicts a front view of one alternative embodiment of the invention having a dual function heat transfer surface;

FIG. 10 depicts a detail top view of one alternative embodiment of the invention having a low pressure drop tube configuration;

FIG. 11 depicts a detail top view of one alternative embodiment of the invention having an intermediate pressure drop tube configuration;

FIG. 12 depicts a detail top view of one alternative embodiment of the invention having a high pressure drop tube configuration;

FIG. 13 depicts a detail top view of one alternative embodiment of the invention having a mixed pressure drop tube configuration;

FIG. 14 depicts a detail partial top view of one alternative embodiment of the invention having a low pressure drop tube configuration;

FIG. 15 depicts a detail partial top view of one alternative embodiment of the invention having and intermediate pressure drop tube configuration;

FIG. 16 depicts a detail partial top view of one alternative embodiment of the invention having a high pressure drop tube configuration;

FIG. 17a depicts a detail partial top view of one alternative embodiment of a fin configuration for a tube of the invention;

FIG. 17b depicts a detail partial side view of one alternative embodiment of a fin as used on a tube in one embodiment of the invention;

FIG. 18 depicts a detail partial side view of one alternative embodiment of fin configurations for tubes within a high, intermediate, low, and minimum pressure drop zones of the invention; and

FIG. 19 depicts a partial isometric view of one alternative embodiment of a bundle of dual function heat surfaces of the invention.

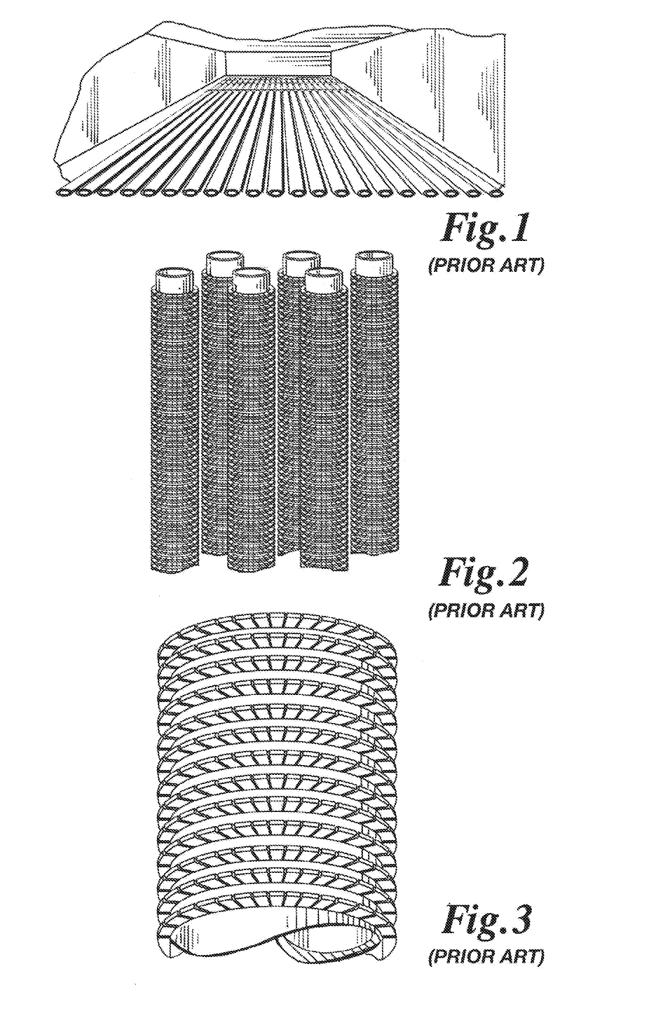

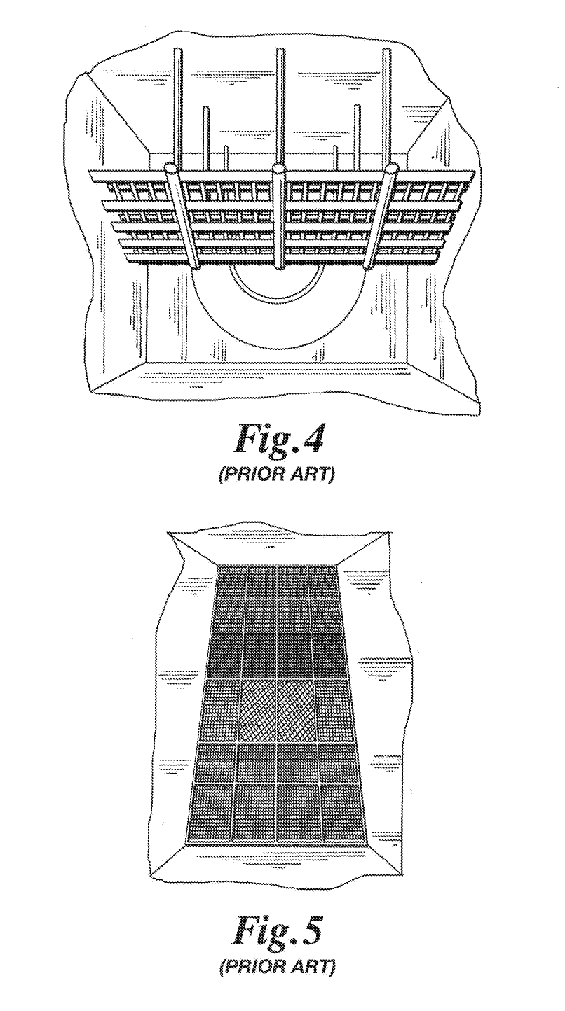

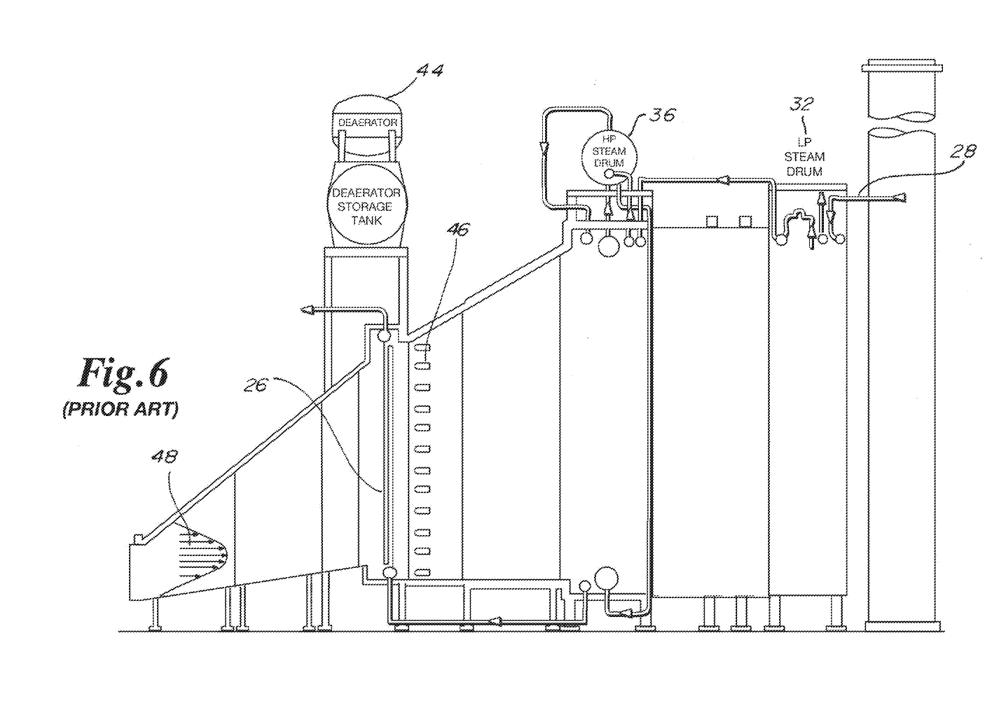

### DETAILED DESCRIPTION OF THE PREFERRED EMBODIMENTS

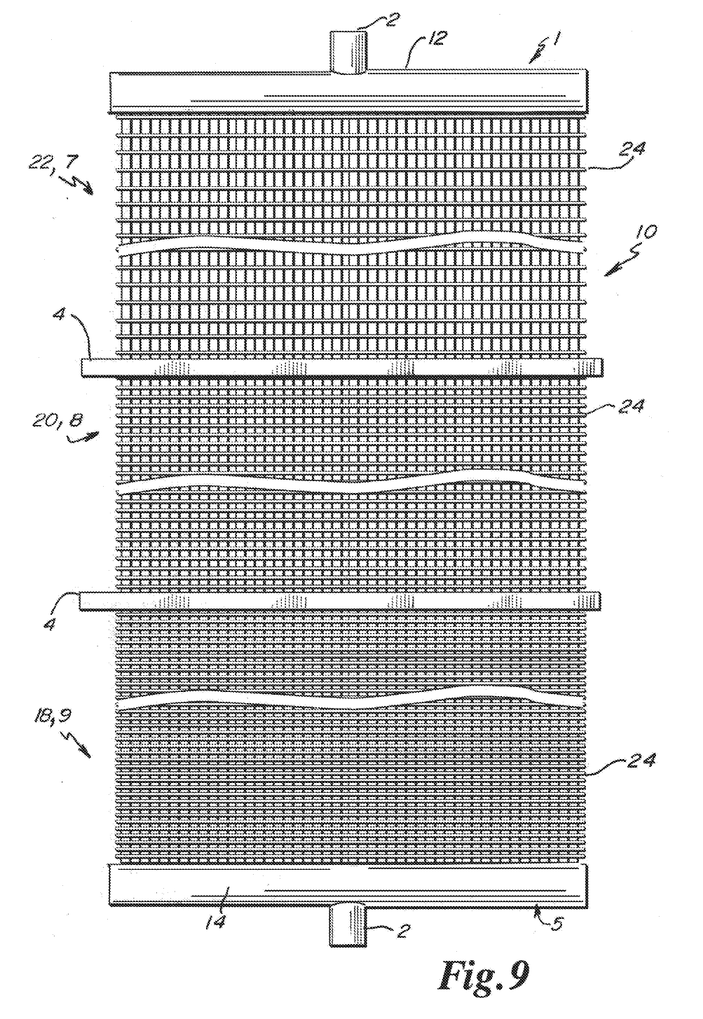

In at least one embodiment of the present invention as depicted in FIGS. 9, 10, 11, 12, 13, and 18 a tube panel 10 is shown. Tube panel 10 may be formed of an upper header 1 and lower header 5 with interconnecting inlet piping 12 and outlet piping 14 having header nozzles 2. In at least one embodiment, the tube panel 10 includes any desired number of varying pressure drop areas which will modify the gas flow characteristics of exhaust gas exiting the exhaust port of a combustion turbine. The varying pressure drop areas may be disposed vertically relative to each other in any desired combination or positional location.

In some embodiments the modification of the gas flow characteristics of exhaust gas exiting the exhaust port of a combustion turbine will be achieved by varying the heat transfer tube placement and/or the tube fin 24 density. In a high pressure drop finning configuration five to six fins 24 may be used per inch. A high pressure drop finning configuration is identified by reference numeral 9. A high pressure drop finning configuration may be provided along any desired portion, section or length of a heat transfer tube 16, or along the entire length of a heat transfer tube 16.

In an intermediate pressure drop configuration four to five fins 24 may be used per inch. An intermediate pressure drop finning configuration is identified by reference numeral 8. An intermediate pressure drop finning configuration 8 may be provided along any desired portion, section or length of a heat transfer tube 16, or along the entire length of a heat transfer tube 16, in order to establish a moderate pressure drop at a desired location.

In a low pressure drop configuration two to four fins 24 may be used per inch. A low pressure drop finning configuration is identified by reference numeral 7. A low pressure drop finning configuration 7 may be provided along any desired portion, section or length of a heat transfer tube 16, or along the entire length of a heat transfer tube 16, in order to establish a lower pressure drop at a desired location.

In some embodiments, bare tubes 6 having no fins 24 per inch may provide a minimal pressure drop. (FIG. 18) The high, intermediate, low or minimal fin arrangements 9, 8, 7, and 6 respectively, for a desired pressure drop may be used in any combination to regulate the desired flow characteristics for exhaust gas exiting a combustion turbine.

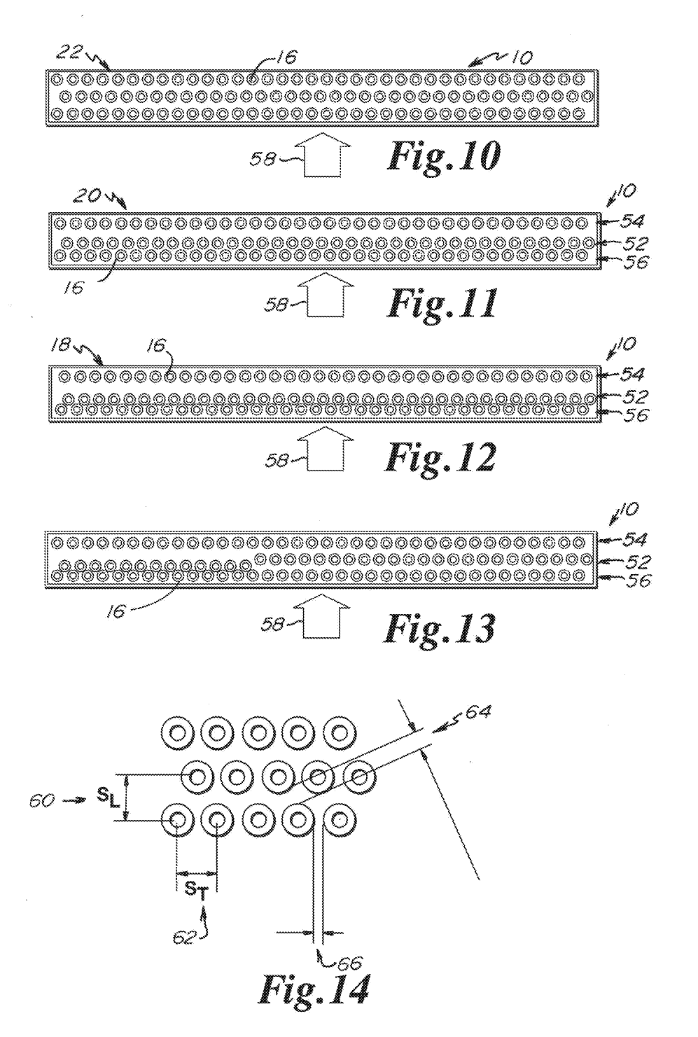

In some embodiments, tube restraints or tube ties 4 may be used to modify or vary the spacing between adjacent heat transfer tubes 16, or heat transfer tubes 16 located proximate to each other longitudinally, or disposed along the length of the tube panel 10, creating a high pressure drop zone referred to generally by reference numeral 18 in FIG. 12, an intermediate pressure drop zone referred to generally by reference numeral 20 in FIG. 11, and a low pressure drop zone referred to generally by reference numeral 22 in FIG. 10. Alternatively, in some embodiments, the pressure drop characteristics may also be varied across a single panel upper header 1 or a single panel lower header 5 as shown in FIG. 13.

In at least one embodiment as depicted in FIG. 6 a typical heat transfer system including a perforated plate 26 is shown. As may be seen in FIG. 6 the heat transfer system includes a low pressure steam drum 32 having a high pressure feed water inlet 28 where the feed water enters into an economizer. The economizer is in fluid flow relationship with a low pressure evaporator. Fluid then flows to the high pressure steam drum 36 which includes a high pressure economizer, a high pressure evaporator, and a high pressure super heater. Fluid may then flow into a deaerator 44, where fluid leaves the deaerator 44 as high pressure steam. Adjacent to the deaerator 44 is located a burner 46 which has a velocity profile that is +−10% of the flow velocity. A perforated plate 26 may be positioned exterior to the burner 46 to be exposed to exhaust gases. The perforated plate 26 may have various settings including 30% open, 50% open, and/or 60% open. As seen in FIG. 6 a velocity profile 48 is identified downstream from the perforated plate 26.

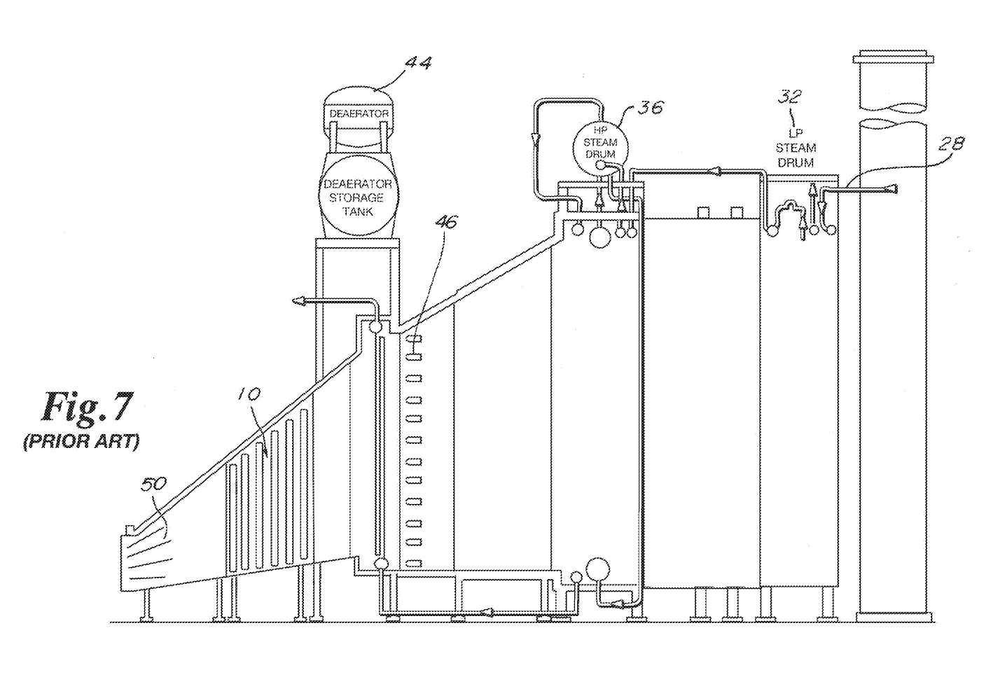

In at least one embodiment as depicted in FIG. 7 the heat transfer system is substantially identical to the heat transfer system as depicted in FIG. 6, with the exception that turning vanes 50 are disposed proximate to the exhaust. FIG. 7 does not depicted the velocity profile 48. In FIG. 7 the turning vanes 50 replace the perforated plate 26. In addition, as may be seen in FIG. 7, in some embodiments a tube panel 10 will be disposed for fluid flow communication with the exhaust gas to establish a velocity profile in a location at or near the position as identified for the perforated plate 26.

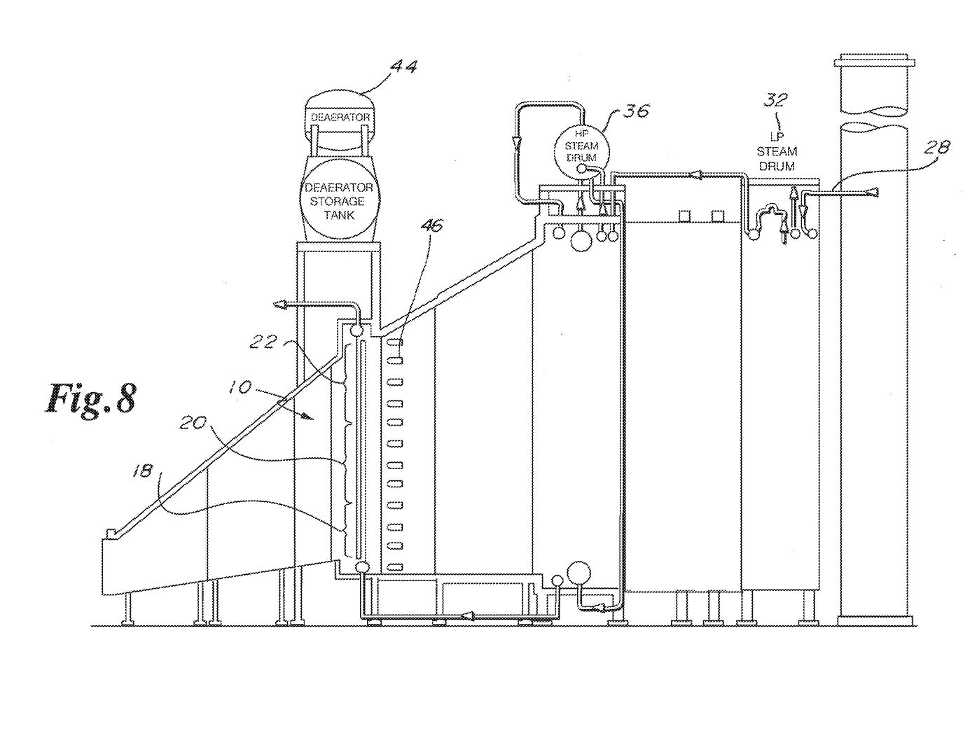

In at least one embodiment as depicted in FIG. 8 the dual function heat transfer surface/system is disclosed. The system of FIG. 8 is substantially identical to the heat transfer system as depicted in FIG. 6, with the exception that a tube panel 10 is provided having the high pressure drop zone 18, intermediate pressure drop zone 20, and low pressure drop zone 22, which are positioned at a location proximate to the exhaust of the super heater in substitution for the perforated plate 26.

In some embodiments, in addition to the high pressure drop zone 18, intermediate pressure drop zone 20, and low pressure drop zone 22, as identified in FIG. 8 and FIG. 9, additional pressure drop zones may be utilized vertically to supplement the pressure drop zones as identified.

In some embodiments as shown in FIG. 9 a tube panel 10 of the invention is shown. The tube panel 10 includes a panel upper header 1 at the top of the panel and a panel lower header 5 at the bottom of the panel. Each of the panel upper header 1 and panel lower header 5 include a header nozzle 2 permitting flow into and out of the tube panel 10. The panel upper header 1 may also include inlet piping 12 and the panel lower header 5 may also include outlet piping 14. It should be noted that the direction of flow within the tube panel 10 may be reversed. In some embodiments the tube panel 10 proximate to the top, may include heat transfer tubes 16 which are bare of fins 24 as depicted by reference numeral 6. (FIG. 18) Below the section of bare tubes 6 may be located a section of heat transfer tubes 16 having low pressure drop finning 7. The low pressure drop finning 7 on the heat transfer tubes 16 in some embodiments may decrease the number of fins 24, decrease the size of fins 24 and may also increase the separation dimension or distance between fins 24 which are proximate to each other in either the vertical or horizontal direction.

In some embodiments as shown in FIG. 9, tube ties 4 will be located between the low pressure drop finning 7 and the intermediate pressure drop finning 8. The tube ties 4 are used to establish sections of heat transfer tubes 16 having an identical fin configuration and spacing in order to establish a desired type of pressure drop zone. In addition as shown in FIG. 9, tube ties 4 may be located between the intermediate pressure drop finning 8 and the high pressure drop finning 9.

In at least one embodiment as shown in FIG. 10, within a low pressure drop zone 22 the heat transfer tubes 16 may have a uniform spacing between adjacent tubes within the same row. In addition, uniform spacing may be provided between adjacent rows of heat transfer tubes 16. Further, adjacent rows of heat transfer tubes 16 may be slightly offset relative to each other so that an individual heat transfer tube 16 is generally disposed in the space between two heat transfer tubes 16 of an adjacent row. In addition to the three rows of heat transfer tubes 16 identified in FIG. 10, it should be noted that any number of rows of heat transfer tubes 16 may be utilized to establish a desired exhaust gas velocity profile. In some embodiments, heat transfer tubes 16 within a low pressure drop zone 22 may not include fins 24. Alternatively, the heat transfer tubes 16 may include fins 24 which are disposed at a greater dimensional distance away from, or relative to each other, in order to establish a desired exhaust gas velocity profile.

Alternatively, the heat transfer tubes 16 may include fins 24 having decreased surface area dimensions and/or thickness in order to establish a desired exhaust gas velocity profile in the low pressure drop zone 22.

In some embodiments, more or less than three rows of heat transfer tubes 16 may be used to form a low pressure drop zone 22. In addition, the diameter dimension of the heat transfer tubes 16 may be decreased in order to establish a desired exhaust gas velocity profile. Further, in some embodiments is not required that each of the heat transfer tubes 16 forming a tube panel 10 within a low pressure drop zone 22 include identical features, which may include, but are not necessarily limited to tube diameter, fin 24 spacing, and/or fin 24 size or dimensions. In some embodiments, any combination of heat transfer tube 16 diameter size, fin 24 spacing and/or fin 24 size or dimension may be combined together to provide the desired exhaust gas velocity profile in the low pressure drop zone 22.

In some embodiments as shown in FIG. 11, the heat transfer tubes 16 within an intermediate pressure drop zone 20 are identified having regular spacing between adjacent heat transfer tubes 16 within an individual row. However, a second row 52 of heat transfer tubes 16 may be separated from the first row 54 of heat transfer tubes 16 by an increased dimension as compared to the separation distance between the second row 52 and the third row 56 of heat transfer tubes 16, which are disposed in close proximity to each other.

In some embodiments the heat transfer tubes 16 within an intermediate pressure drop zone 20 between adjacent rows are offset relative to each other to dispose a heat transfer tube 16 between two heat transfer tubes 16 in an adjacent row. In some embodiments within an intermediate pressure drop zone 20 the first row 54 and second row 52 of heat transfer tubes may be adjacent to each other and the third row 56 of heat transfer tubes may be separated from the second row 52 of heat transfer tubes by an increased spatial dimension.

In addition to the three rows of heat transfer tubes 16 identified in FIG. 11, it should be noted that any number of rows of heat transfer tubes 16 may be utilized to establish a desired exhaust gas velocity profile within an intermediate pressure drop zone 20.

In some embodiments, heat transfer tubes 16 within an intermediate pressure drop zone 20 may include fins 24. The fins 24 on the heat transfer tubes 16 within the intermediate pressure drop zone 20 may be disposed a smaller distance away from, or relative to each other, as compared to the low pressure drop zone 22, in order to establish a desired exhaust gas velocity profile. Alternatively, the heat transfer tubes 16 may include fins 24 having an increased surface area dimensions and/or thickness as compared to the fins 24 on heat transfer tubes 16 within the low pressure drop zone 22.

In some embodiments, more or less than three rows of heat transfer tubes 16 may be used to form an intermediate pressure drop zone 20. In addition, the diameter dimension of the heat transfer tubes 16 in the intermediate pressure drop zone 20 may be increased relative to the low pressure drop zone 22 in order to establish a desired exhaust gas velocity profile. Further, in some embodiments it is not required that each of the heat transfer tubes 16 forming a tube panel 10 within an intermediate pressure drop zone 20 include identical features, which may include, but are not necessarily limited to tube diameter, fin 24 spacing, and/or fin 24 size or dimensions. In some embodiments, any combination of heat transfer tube 16 diameter size, fin 24 spacing and/or fin 24 size or dimension may be combined together to provide the desired exhaust gas velocity profile in the intermediate pressure drop zone 20.

In some embodiments as depicted in FIG. 12 for a high pressure drop zone 18, the second row 52 and third row 56 of heat transfer tubes 16 may be in close proximity to each other, and in an alternative embodiment the fins 24 of the second row 52 and the third row 56 of heat transfer tubes 16 may contact each other. In some embodiments as shown in FIG. 12, the heat transfer tubes 16 within a high pressure drop zone 18 are identified having regular spacing between adjacent heat transfer tubes 16 within an individual row. However, a second row 52 of heat transfer tubes 16 may be separated from the first row 54 of heat transfer tubes 16 by an increased dimension as compared to the separation distance between the second row 52 and the third row 56 of heat transfer tubes 16, which may disposed in contact with each other.

In some embodiments the heat transfer tubes 16 within a high pressure drop zone 18 between adjacent rows are offset relative to each other to dispose a heat transfer tube 16 between two heat transfer tubes 16 in an adjacent row. In some embodiments within a high pressure drop zone 18 the first row 54 and second row 52 of heat transfer tubes may be adjacent to each other and the third row 56 of heat transfer tubes may be separated from the second row 52 of heat transfer tubes by an increased spatial dimension.

In addition to the three rows of heat transfer tubes 16 identified in FIG. 12, it should be noted that any number of rows of heat transfer tubes 16 may be utilized to establish a desired exhaust gas velocity profile within a high pressure drop zone 18. In some embodiments, heat transfer tubes 16 within a high pressure drop zone 18 may include fins 24. The fins 24 on the heat transfer tubes 16 within the high pressure drop zone 18 may be disposed a smaller distance away from, or relative to each other, as compared to the intermediate pressure drop zone 20, in order to establish a desired exhaust gas velocity profile. Alternatively, the heat transfer tubes 16 may include fins 24 having an increased surface area dimensions and/or thickness as compared to the fins 24 on heat transfer tubes 16 within the intermediate pressure drop zone 20, in order to establish a desired exhaust gas velocity profile.

In some embodiments, more or less than three rows of heat transfer tubes 16 may be used to form a high pressure drop zone 18. In addition, the diameter dimension of the heat transfer tubes 16 in the high pressure drop zone 18 may be increased relative to the intermediate pressure drop zone 20 in order to establish a desired exhaust gas velocity profile. Further, in some embodiments it is not required that each of the heat transfer tubes 16 forming a tube panel 10 within a high pressure drop zone 18 include identical features, which may include, but are not necessarily limited to tube diameter, fin 24 spacing, and/or fin 24 size or dimensions. In some embodiments, any combination of heat transfer tube 16 diameter size, fin 24 spacing and/or fin 24 size or dimension may be combined together to provide the desired exhaust gas velocity profile in the high pressure drop zone 18.

In some embodiments, as depicted in FIG. 13, any desired portion of a tube panel 10 may include any desired configuration of heat transfer tube spacing between adjacent heat transfer tubes 16 and adjacent rows of heat transfer tubes 16. For example, in the left section or portion of the tube panel 10 disclosed in FIG. 13, the second row 52 and the third row 56 of heat transfer tubes 16 are spatially separated from the first row 54 of heat transfer tubes 16. In addition, in the left section or portion of the tube panel 10 disclosed in FIG. 13, the heat transfer tubes 16 in each of the second row 52 and the third row 56 are closely longitudinally spaced, or are in contact with each other. In addition, in the left section of the tube panel 10 as disclosed in FIG. 13, the second row 52 of heat transfer tubes 16 is in close proximity to the third row 56 of heat transfer tubes 16 and in some embodiments may be in contact with each other.

As shown in FIG. 13, in some embodiments in the middle portion or section, and right portion or section, of the tube panel 10, the first row 54, second row 52, and third row 56 of heat transfer tubes 16 are regularly and uniformly spaced relative to each other. In some embodiments, any spacing between heat transfer tubes 16 within an individual row or between rows of adjacent heat transfer tubes 16 may be utilized within sections or portions of a tube panel 10 in any combination, to provide a desired velocity profile. In addition, in some embodiments, the spacing between adjacent heat transfer tubes 16 within an individual row may be adjusted, where certain heat transfer tubes 16 are compacted relative to each other, and where other heat transfer tubes 16 are separated or regularly spaced relative to each other longitudinally along the length of the row within the tube panel 10.

Further, in some embodiments, the size of the diameter of the heat transfer tubes 16 within an individual row may vary, where certain heat transfer tubes 16 have a larger or smaller diameter dimension relative to another of the heat transfer tubes 16 along the length of the row within the tube panel 10. In addition, heat transfer tubes 16 may have a larger or smaller diameter dimension between rows of heat transfer tubes 16 in any combination, within the tube panel 10.

In some embodiments the heat transfer tubes 16 within a pressure drop zone between adjacent rows may be aligned or offset relative to each other. In addition to the three rows of heat transfer tubes 16 identified in FIG. 13, it should be noted that any number of rows of heat transfer tubes 16 may be utilized to establish a desired exhaust gas velocity profile within a pressure drop zone.

In some embodiments, heat transfer tubes 16 within a pressure drop zone may include fins 24. The fins 24 on the heat transfer tubes 16 within a pressure drop zone may be disposed either a larger or a smaller distance away from, or relative to each other, as compared to another row or section of a tube panel 10, in order to establish a desired exhaust gas velocity profile. Alternatively, the heat transfer tubes 16 may include fins 24 having either an increased or decreased surface area dimensions and/or thickness as compared to the fins 24 on adjacent heat transfer tubes 16 or within adjacent rows of heat transfer tubes 16 within a pressure drop zone in order to establish a desired exhaust gas velocity profile.

In FIGS. 10 through 13 the flow of heated air through tube panel 10 which is used to create a desired pressure drop zone is depicted by arrow 58. It should be noted that the velocity profiles established by the pressure drop zones depicted in FIGS. 10-13 may be vertically arranged in any combination. In alternative embodiments, a velocity profile established by a pressure drop zone may use only one or more of the pressure drop zones depicted in FIGS. 10-13 in any combination.

In some embodiments as depicted in FIGS. 14, 15, and 16 the longitudinal spacing between heat transfer tubes 16, the separation distance and/or spacing of heat transfer tubes 16 into bundles within a particular row, the spacing between the rows of heat transfer tubes 16 in a tube panel 10, and the alignment of the heat transfer tubes 16 between adjacent rows of heat transfer tubes 16 within a tube panel 10, may vary in order to provide or to modify the gas flow characteristics through the tube panel 10.

In at least one embodiment as depicted in FIG. 14 a low pressure drop configuration or zone 22 may have a longitudinal tube to tube spacing dimension (depicted by SL (reference numeral 60)) of 3.5 to 5.0 inches, a transverse tube to tube spacing dimension (depicted by ST (reference numeral 62)) of 3.5 to 4.625 inches, and aligned tube spacing dimension 64 of 0.5 to 0.75 inches. In other embodiments, the low pressure drop zone 22 longitudinal tube to tube spacing dimension SL 60 may be greater than 3.5 to 5.0 inches, and the transverse tube to tube spacing dimension ST 62 may be greater than 3.5 to 4.625 inches, and the aligned tube spacing dimension 64 may be greater than 0.5 to 0.75 inches. In other embodiments, the low pressure drop zone 22 longitudinal tube to tube spacing dimension SL 60 may be less than 3.5 to 5.0 inches, and the transverse tube to tube spacing dimension ST 62 may be less than 3.5 to 4.625 inches, and the aligned tube spacing dimension 64 may be less than 0.5 to 0.75 inches. It should be noted that the dimensions identified herein have been provided for illustrative purposes, and may be increased, decreased, or varied dependent upon the requirements of a particular tube panel 10. In FIG. 14, the fin tip to fin tip separation dimension between adjacent heat transfer tubes 16 within a particular row is depicted by reference numeral 66.

In at least one embodiment as depicted in FIG. 15, an intermediate pressure drop configuration or zone 20 may have a longitudinal tube to tube spacing dimension SL 60 of 3.0 to 4.5 inches, a transverse tube to tube spacing dimension ST 62 of 3.5 to 4.625 inches, and an aligned tube spacing dimension 64 of 0.125 to 0.75 inches. In other embodiments, the intermediate pressure drop zone 20 longitudinal tube to tube spacing dimension SL 60 may be greater than 3.0 to 4.5 inches, and the transverse tube to tube spacing dimension ST 62 may be greater than 3.5 to 4.625 inches, and the aligned tube spacing dimension 64 may be greater than 0.125 to 0.75 inches. In other embodiments, the intermediate pressure drop zone 20 longitudinal tube to tube spacing dimension SL 60 may be less than 3.0 to 4.5 inches, and the transverse tube to tube spacing dimension ST 62 may be less than 3.5 to 4.625 inches, and the aligned tube spacing dimension 64 may be less than 0.125 to 0.75 inches. It should be noted that the dimensions identified herein have been provided for illustrative purposes, and may be increased, decreased, or varied dependent upon the requirements of a particular tube panel 10.

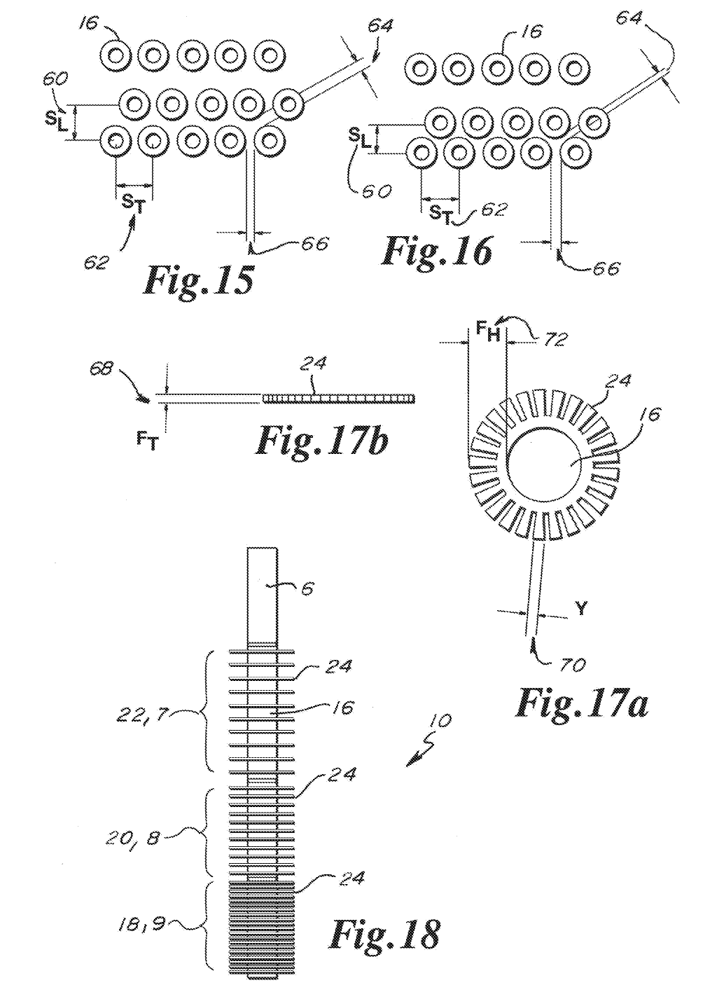

In at least one embodiment as depicted in FIG. 16, a high pressure drop configuration or zone 18 may have a longitudinal tube to tube spacing dimension SL 60 of 2.75 to 4.0 inches, a transverse tube to tube spacing dimension ST 62 of 3.5 to 4.625 inches, and aligned tube spacing dimension 64 of 0 (fin tips touching) to 0.250 inches. In other embodiments, the high pressure drop zone 18 longitudinal tube to tube spacing dimension SL 60 may be greater than 2.75 to 4.0 inches, and the transverse tube to tube spacing dimension ST 62 may be greater than 3.5 to 4.625 inches, and the aligned tube spacing dimension 64 may be greater than 0 (fin tips touching) to 0.250 inches. In other embodiments, the high pressure drop zone 18 longitudinal tube to tube spacing dimension SL 60 may be less than 2.75 to 4.0 inches, and the transverse tube to tube spacing dimension ST 62 may be less than 3.5 to 4.625 inches, and the aligned tube spacing dimension 64 may be less than 0.250 inches. It should be noted that the dimensions identified herein have been provided for illustrative purposes, and may be increased, decreased, or varied dependent upon the requirements of a particular tube panel 10.

In at least one embodiment as depicted in FIGS. 17a and 17b, the tube fin 24 geometry dimensions may vary between one or more of the possible pressure drop configurations or zones. In some embodiments, the fin 24 thickness dimension FT 68 will be between 0.039 to 0.059 inches, and the finning segment width Y dimension 70 will be between 0.15 to 0.2 inches for all pressure drop configurations or zones. In other embodiments the fin 24 thickness dimension FT 68 will be greater than between 0.039 to 0.059 inches, and the finning segment width Y dimension 70 will be greater than between 0.15 to 0.2 inches for the low pressure drop zone 22. In other embodiments the fin 24 thickness dimension FT 68 will be less than between 0.039 to 0.059 inches, and the finning segment width Y dimension 70 will be less than between 0.15 to 0.2 inches for high pressure drop zone 18. It should be noted that the dimensions identified herein have been provided for illustrative purposes, and may be increased, decreased, or varied dependent upon the requirements of a particular tube panel 10.

In some embodiments the fin 24 height dimension FH 72 may be varied to modify the gas flow characteristics through the tube panel 10. In a high pressure drop zone 18 the fin 24 height dimension FH 72 may range from approximately 0.625 to 0.75 inches. In other embodiments, in a high pressure drop zone 18, the fin 24 height dimension FH 72 may be greater than approximately 0.625 to 0.75 inches and in other embodiments the fin 24 height dimension FH 72 in a high pressure drop zone 18 may be less than approximately 0.625 to 0.75 inches. It should be noted that the dimensions identified herein have been provided for illustrative purposes, and may be increased, decreased, or varied dependent upon the requirements of a particular tube panel 10.

In some embodiments the fin 24 height dimension FH 72 in an intermediate pressure drop zone 20 may range from approximately 0.375 to 0.75 inches. In other embodiments, the fin 24 height dimension FH 72 in an intermediate pressure drop zone 20 may be greater than approximately 0.375 to 0.75 inches, and in other embodiments the fin 24 height dimension FH 72 in an intermediate pressure drop zone 20, may be less than approximately 0.375 to 0.75 inches. It should be noted that the dimensions identified herein have been provided for illustrative purposes, and may be increased, decreased, or varied dependent upon the requirements of a particular tube panel 10.

In some embodiments the fin 24 height dimension FH 72 in a low pressure drop zone 22 may range from approximately 0.2 to 0.5 inches. In other embodiments, the fin 24 height dimension FH 72 in a low pressure drop zone 22 may be greater than approximately 0.2 to 0.5 0.75 inches and in other embodiments the fin 24 height dimension FH 72 in a low pressure drop zone 22, may be less than approximately 0.2 to 0.5 inches. It should be noted that the dimensions identified herein have been provided for illustrative purposes, and may be increased, decreased, or varied dependent upon the requirements of a particular tube panel 10.

In alternative embodiments, the fins 24 may be directly engaged to the exterior surface of a heat transfer tube 16. In at least one embodiment, the extended surface or fins 24 are preferably formed of metal material. Generally, the heat transfer tubes 16 as identified herein are disposed vertically relative to each other in order to define a vertical axis. In an alternative embodiment, the heat transfer tubes 16 may be disposed horizontally relative to each other. In some embodiments, the fins 24 extend outwardly from the heat transfer tubes 16 in a direction which is perpendicular to the vertical axis. In some embodiments, the fins 24 may be aligned horizontally and/or aligned vertically, where adjacent fins 24 are parallel to each other and fins 24 on adjacent drop zone levels are vertically aligned relative to each other.

In some alternative embodiments, the fins 24 may be aligned vertically or offset vertically in a desired pattern or configuration, one example of which may be to form a spiral. In an alternative embodiment, the fins 24 may extend outwardly from the heat transfer tube 16 and may be disposed at an angle relative to the vertical axis. In this embodiment, adjacent fins 24 are angularly offset relative to a vertical axis and may be parallel to each other. In some alternative embodiments, the angled fins 24 may be aligned vertically or offset vertically in a desired pattern or configuration, one example of which may be to form a spiral.

In some embodiments, the fins 24 may have uniform size dimensions and/or shapes creating a unitary structure without spaces between adjacent fins 24. In alternative embodiments the fins 24 may be formed in a segmented configuration with a space between adjacent fins 24. The space between adjacent fins 24 may be increased or decreased in dimension, uniform, and/or non-uniform, dependent on a desired high pressure drop zone 18, intermediate pressure drop zone 20, or low-pressure drop zone 22 in order to provide a desired gas velocity profile.

In some embodiments, any fin 24 configuration or fin 24 spacing as disclosed herein may be utilized in any combination with one or more of any other fin 24 configuration or spacing as alternatively described. In addition any number of sections or sectors of fins 24 may be utilized to provide a desired exhaust gas flow velocity profile.

In some embodiments as shown in FIG. 18, in a high pressure drop zone 18 the fins 24 as disposed on the tube panel 10 are tightly spaced vertically relative to each other. In the high pressure drop zone 18 the number of fins 24 is maximized vertically along a desired portion of the tube panel 10. In the intermediate pressure drop zone 20, the number of fins 24 disposed in the tube panel 10 is reduced, and the spacing between adjacent fins 24 is increased relative to the high pressure drop zone 18. In the low-pressure drop zone 22, the number of fins 24 disposed on the tube panel 10 is further reduced relative to the spacing in the intermediate pressure drop zone 20. In addition in the low pressure drop zone 22 the spacing between adjacent fins 24 on the tube panel 10 is increased in either of the vertical or horizontal directions. In addition, the spacing between heat transfer tubes 16 in the low pressure drop zone 22 is increased relative to the intermediate pressure drop zone 20.

In some embodiments spacing between adjacent heat transfer tubes 16 within a row of tubes in a tube panel 10 is obtained through the use of tube ties, restraints, fasteners, or tube frames 4 having a desired spacing configuration. In addition, in some embodiments, the spacing between adjacent rows of heat transfer tubes 16 within a tube panel 10 is obtained through the use of tube ties, restraints, fasteners, or tube frames having a desired spacing and/or positioning configuration.

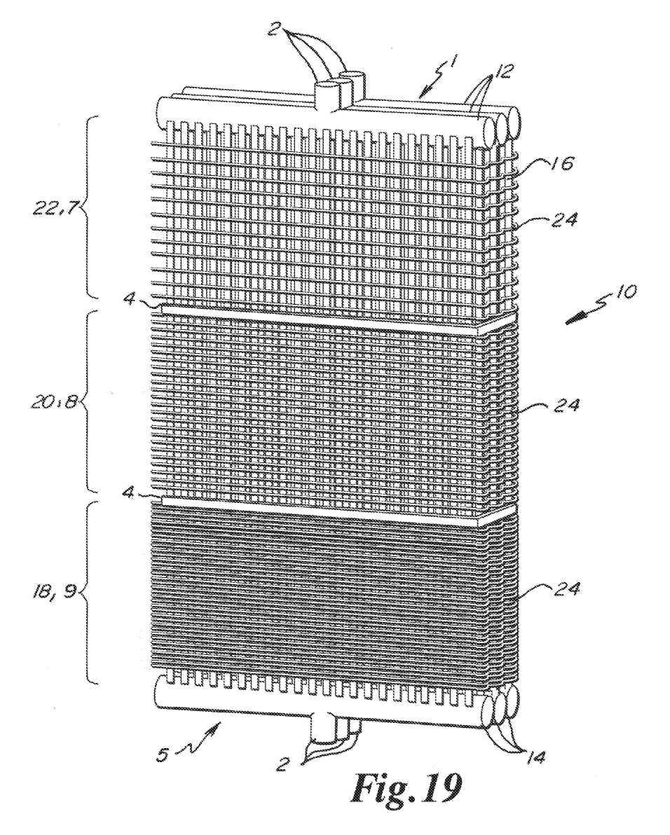

In at least one embodiment as depicted in FIG. 19, the tube panel 10 or multiple tube panels 10 may positioned adjacent to each other, where each tube panel 10 may be comprised of areas of low, intermediate, and/or high gas pressure drop zones 22, 20 and 18 respectively, with the highest gas pressure drop being typically located at the bottom of a tube panel 10. A “bundle” of heat transfer tubes 16 is a term used to describe multiple conjoined tube panels 10.

In a first alternative embodiment, a heat transfer device is disclosed comprising: a plurality of tubes, the plurality of tubes being disposed in rows of tubes, the rows of tubes forming a tube panel wherein the plurality of rows of tubes are vertically organized into a least a first pressure drop zone and a second pressure drop zone.

In a second alternative embodiment according to the first alternative embodiment, the plurality of tubes within at least one of the rows of the plurality of tubes are uniformly spaced relative to another of the plurality of tubes within the at least one of the rows of tubes.

In a third alternative embodiment according to the first alternative embodiment, the plurality of tubes within at least one of the rows of the plurality of tubes are irregularly spaced relative to another of the plurality of tubes within the at least one of the rows of tubes.

In a fourth alternative embodiment according to the first alternative embodiment, the plurality of tubes within the first pressure drop zone are separated from each other a first distance, and the plurality of tubes within the second pressure drop zone are separated from each other a second distance, the first distance having a different dimension as compared to the second distance.

In a fifth alternative embodiment according to the first alternative embodiment, a plurality of fins may be engaged to at least one of the plurality of tubes where a first number of fins may be engaged to each of the plurality of tubes in the first pressure drop zone and a second number of fins may be engaged to each of the plurality of tubes in the second pressure drop zone, the first number of fins being different from the second number of fins.

In a sixth alternative embodiment according to the second alternative embodiment, the spacing between adjacent rows of tubes defines a transverse tube spacing having a dimension, the dimension being constructed and arranged to be variable and to modify a gas flow characteristic of the heat transfer device to achieve a desired flow distribution.

In a seventh alternative embodiment according to the first alternative embodiment, the tube panel is constructed and arranged to act as a heat transfer surface and is constructed and arranged to distribute turbulent combustion turbine exhaust flow.

In an eighth alternative embodiment according to the fifth alternative embodiment, the first number of fins and the second number of fins are constructed and arranged to establish a desired exhaust gas flow distribution downstream from the tube panel.

In a ninth alternative embodiment according to the first alternative embodiment, the tube panel comprises a panel upper header and a panel lower header, each of the panel upper header and the panel lower header having a header nozzle.

In a tenth alternative embodiment according to the first alternative embodiment, the heat transfer device further comprises tube ties, wherein the tube ties secure the plurality of tubes into the first pressure drop zone and the second pressure drop zone.

In an eleventh alternative embodiment according to the first or fifth alternative embodiments, at least one of the plurality of rows of tubes are vertically organized into an intermediate pressure drop zone.

In a twelfth alternative embodiment according to the eleventh alternative embodiment, the plurality of tubes within the intermediate pressure drop zone are separated from each other a third distance, the third distance being smaller than the second distance and the third distance being larger than the first distance.

In a thirteenth alternative embodiment according to the twelfth alternative embodiment, a third number of fins is engaged to at least one of the plurality of tubes in the intermediate pressure drop zone, the third number of fins being larger than the second number of fins, and the third number of fins being smaller than the first number of fins.

In a fourteenth alternative embodiment according to the thirteenth alternative embodiment, the first number of fins, the third number of fins, and the second number of fins are constructed and arranged to establish a desired exhaust gas flow distribution downstream from the tube panel.

In another alternative embodiment, a tube panel, or multiple panels will act as both a heat transfer surface utilized in a waste heat boiler as part of the Rankin cycle, as well as a device to distribute turbulent combustion turbine exhaust flow for downstream components which require uniform gas flow.

In another alternative embodiment, a tube panel, or multiple panels have extended surfaces, where the extended surfaces along the length of the tubes is varied in order to achieve a desired exhaust gas flow distribution.

In another alternative embodiment, a tube panel, or multiple panels include a longitudinal tube spacing between the tubes which is varied to modify the gas flow characteristics to achieve desired flow distribution.

This completes the description of the preferred and alternate embodiments of the invention. Those skilled in the art may recognize other equivalents to the specific embodiment described herein which equivalents are intended to be encompassed by the claims attached hereto.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

I claim:

1. A heat transfer device comprising:
a plurality of tubes, said plurality of tubes being disposed in rows of tubes, said rows of tubes forming a tube panel wherein said plurality of rows of tubes are vertically organized into a least a first pressure drop zone and a second pressure drop zone.

2. The heat transfer device according to claim 1, wherein said plurality of tubes within at least one of said rows of said plurality of tubes are uniformly spaced relative to another of said plurality of tubes within said at least one of said rows of tubes.

3. The heat transfer device according to claim 1, wherein said plurality of tubes within at least one of said rows of said plurality of tubes are irregularly spaced relative to another of said plurality of tubes within said at least one of said rows of tubes.

4. The heat transfer device according to claim 1, wherein said plurality of tubes within said first pressure drop zone are separated from each other a first distance, and said plurality of tubes within said second pressure drop zone are separated from each other a second distance, said first distance having a different dimension as compared to said second distance.

5. The heat transfer device according to claim 1, a plurality of said tubes comprising a plurality of fins, wherein a first number of fins are engaged to each of said plurality of tubes in said first pressure drop zone and a second number of fins are engaged to each of said plurality of tubes in said second pressure drop zone, the first number of fins being different from the second number of fins.

6. The heat transfer device according to claim 2, wherein the spacing between adjacent of said plurality of tubes in said row of said plurality of tubes is a transverse tube spacing having a dimension, said dimension being constructed and arranged to be variable and to modify a gas flow characteristic of said heat transfer device to achieve a desired flow distribution.

7. The heat transfer device according to claim 1, wherein said tube panel is constructed and arranged to act as a heat transfer surface and is constructed and arranged to distribute turbulent combustion turbine exhaust flow.

8. The heat transfer device according to claim 5, wherein the first number of fins and the second number of fins are constructed and arranged to establish a desired exhaust gas flow distribution downstream from said tube panel.

9. The heat transfer device according to claim 1, said tube panel comprising a panel upper header and a panel lower header, each of said panel upper header and said panel lower header having a header nozzle.

10. The heat transfer device according to claim 1, further comprising tube ties, wherein said tube ties secure said plurality of tubes into said first pressure drop zone and said second pressure drop zone.

11. The heat transfer device according to claim 5, wherein at least one of said plurality of rows of tubes are vertically organized into an intermediate pressure drop zone.

12. The heat transfer device according to claim 11, wherein said plurality of tubes within said intermediate pressure drop zone are separated from each other a third distance, said third distance being smaller than said second distance and said third distance being larger than said first distance.

13. The heat transfer device according to claim 12, wherein a third number of fins are engaged to each of said plurality of tubes in said intermediate pressure drop zone, the third number of fins being larger than said second number of fins, and said third number of fins being smaller than said first number of fins.

14. The heat transfer device according to claim 13, wherein the first number of fins, the third number of fins, and the second number of fins are constructed and arranged to establish a desired exhaust gas flow distribution downstream from said tube panel.
